(19) United States
(12) Patent Application Publication
(10) Pub. No.: US 2008/0188299 A1
(43) Pub. Date: Aug. 7, 2008

(54) Monitoring and Controlling of Gaming Entertainment

(76) Inventors: Robert Charles Angell, Kent County, RI (US); James Richard Lavoie, County of New London, CT (US)

Correspondence Address: RYAN, MASON & LEWIS, LLP, 1300 POST ROAD, SUITE 205, FAIRFIELD, CT, 06824, US

(21) Appl. No.: 11/909,893

(22) PCT Filed: Mar. 28, 2006
(86) PCT No.: PCT/US2006/011620

§ 371 Date: Sep. 27, 2007

Related U.S. Application Data
(60) Provisional application No. 60/665,662, filed on Mar. 28, 2005.

(51) Int. Cl. A63F 9/24; G06Q 40/00; G06F 19/00

(52) U.S. Cl. 463/29; 463/25; 705/44

(57) ABSTRACT

An effective means of promoting and enforcing responsible gaming activity on an individual basis is disclosed. A wide area network of gaming terminals is utilized, and does not require the gaming terminals to be centrally monitored or controlled. Eligible players register with the Gaming Authority using proof of age and identity resulting in the issuance of a unique personal device which the player must use to enable a gaming machine. The gaming terminals are equipped with a fitment containing the appropriate hardware and software to monitor and control game play. The fitment includes an identification verifier and a receiver for the unique personal device. The fitments are adaptable to fit into various gaming devices manufactured by providers in the industry.

### RELATED APPLICATIONS

This application claims priority to U.S. Provisional Patent Application No. 60/665,662 entitled “MONITORING AND CONTROLLING OF GAMING EQUIPMENT”, filed Mar. 28, 2005, which is incorporated herein by reference.

### FIELD OF INVENTION

The present invention relates to gaming equipment, more precisely to the monitoring and controlling of a player's use of gaming equipment.

### BACKGROUND

The widespread growth of public gaming has triggered a political and social backlash in certain communities due to the inability of certain players to participate in a financially responsible manner. The inability of certain players to regulate their own gaming participation has put unprecedented pressure on gaming regulators to devise an effective solution to a growing and serious problem. This problem is especially acute with the widespread deployment of Video Lottery Terminals (“VLT”), especially where the deployment is not restricted to specific gaming venues but rather where the VLTs are deployed in local businesses with a high degree of public access. Further, as governments negotiate a percentage of proceeds from VLT and slot activity within the State, there will be increased pressure to adopt a socially conscious posture to protect their citizens from irresponsible game play.

### SUMMARY

The present invention provides for an effective means of promoting and enforcing responsible gaming activity on an individual basis. An embodiment of the present invention utilizes a wide area network of VLTs, and does not require that the VLTs be centrally monitored or controlled.

In an embodiment of the present invention, eligible players register with the Gaming Authority. Registration using proof of age and identity results in the issuance of a unique personal device which the player must use to enable a VLT gaming machine. The VLTs are equipped with a fitment containing the appropriate hardware and software to monitor and control game play. The fitment includes an identification verifier and a receiver for the unique personal device. The fitments are adaptable to fit into various VLT devices manufactured by providers in the industry, such as International Gaming Technology (“IGT”).

In one embodiment, the personal device is inserted or attached to the fitment of a VLT when play is desired. The personal device contains sufficient intelligence and data to, in conjunction with the VLT, establish a spending, or loss limit, for that player and how much of that limit has been achieved in a permissible period of time. When the player decides to play, the personal device is inserted into or attached to the VLT. Based on data and time stamps, for example stored on the personal device, the VLT determines the remaining loss limit for that player. If there is a remaining balance on the device, the player is allowed to continue play. On every play of the machine, the loss limit will be adjusted based on the net calculation of wins and losses. If the loss limit is reached the VLT will cease to operate with that player's personal device until the pre-determined time interval has elapsed.

In an embodiment of the present invention the fitment is interfaced to several disabling features of the VLT that have the ability to arrest the functionality of the VLT. This is done by simulating any one of a number of machine faults that would typically halt the operation of the VLT.

### BRIEF DESCRIPTION OF THE DRAWINGS

The present invention will be more fully understood from the following detailed description of illustrative embodiments taken in conjunction with the accompanying drawings in which:

FIG. 1 is a block representation of a gaming system in accordance with an embodiment of the present invention;

FIG. 2 is a personal device card in accordance with an embodiment of the present invention;

FIG. 3. is an organizational chart of a registration and gaming structure in accordance with an embodiment of the present invention;

FIG. 4A-B are illustrations of gaming systems utilizing a lottery system in accordance with an embodiment of the present invention; and

FIG. 5 is a flow diagram of a method of monitoring and controlling gaming in accordance with an embodiment of the present invention.

### DETAILED DESCRIPTION

Detailed embodiments of the present invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the present invention in virtually any appropriately detailed embodiment.

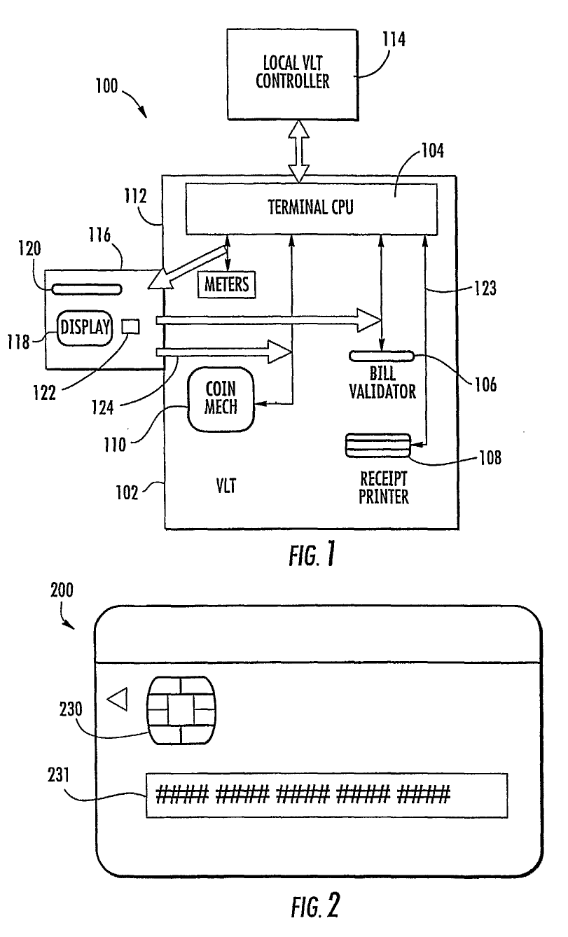

Turning now to FIG. 1, a gaming system 100 is depicted in accordance with an embodiment of the present invention. A video lottery terminal (“VLT”) 102 contains a terminal central processing unit (“CPU”) 104. The CPU 104 is wired to a currency validator 106, a receipt printer 108, a coin mechanism 110 and an accounting meter 112. A VLT controller 114 is coupled to the CPU of the VLT 102 to drive the operation of the machine. In addition to VLTs, embodiments of the present invention may be incorporated into other gaming machines including, but not limited to, traditional slot machines and electronic pay-per-play gaming device, such as multi-game arcade terminals or video poker terminals.

A fitment 116 is attached to the VLT 102. Many commercially available VLTs 102 contain ample space internally or accessible space externally to the VLT housing to allow for facile installation of the fitment 116. The fitment 116 of the present embodiment includes a display 118 and a card reader 120. The fitment may also contain a biometric reader 122 as additional insurance against misuse. For instance, a practical biometric technology would be the inclusion of a simple thumb or fingerprint reader. This reader will be configured when the device is issued to the player such that only that player may use the device for operation of a VLT 102. Countless other biometric security features may also be implemented, including but not limited to, a retinal or ocular scan, or facial recognition. Alternatively, a personal identification number (“PIN”) may be used to authenticate the user's identity.

A player wishing to interact with the VLT 102 inserts a personal card device into the card reader 120. The display 118 then prompts the user to provide identifying information to the biometric reader 122. If the data supplied to the biometric reader 122 matches the biometric data stored on the personal card device, the display 118 will confirm to the player an identification confirmation message. Any of various kinds of biometric readers may be implemented including, but not limited to, fingerprint readers, ocular scanners, facial/feature recognition devices, or the like.

If the players identification is confirmed, the CPU 104 will then poll the personal card device to determine if the player's account has a remaining balance with which the player may bet or use at the VLT 102. As described below, the personal device card will contain information detailing a limit loss amount for a given time period and how much of that loss limit has been achieved during the time period. If the loss limit has been met, the CPU will issue a stop command to the VLT and no game may be played. If the loss limit has not yet been achieved, the CPU will allow the player to proceed with the game until the player chooses to leave the VLT 102 or the loss limit is reached.

An embodiment of the present invention includes digital interfaces to communicate between the local controller 114 and the CPU 104, using established protocols such as Slot Accounting System (“SAS”) or Slot Data System (“SDS”). Alternatively, another embodiment may utilize another protocol allowing the fitment 116 devices to communicate directly with the local controller 114.

In the present embodiment, if the loss limit is achieved, several arresting functions may be implemented to stop the VLT's 102 operation. For instance, a typical VLT 102 will not operate if a service door on the housing is open or unlocked. According to one embodiment of the invention, when the loss limit is reached, the CPU 104 sends a false signal, 123, 124 to the machine controller 114 signifying an open door fault and the VLT 102 will not operate. Other possible arresting functions include, but are not limited to, a fault in the currency validator 106, a coin output door being open, the coin output bank being empty, or the coin collection bank being full 110. The occurrence of any one of these events will halt the VLT from operation. The CPU 104 signals the machine that a fault has occurred and operation will not resume until the fault has been cured. This method of arresting the functionality of the machine allows for a less intrusive installation of the fitment 116 and re-tooling of the VLT 102.

In an embodiment of the present invention, a method for preventing counterfeiting is incorporated into the system. Counterfeiting may be substantially prevented by implementing a strong encryption system between the personal card device and the VLT, which encryption system uses a key that is unique to each device. For out-of-region guests, a courtesy card methodology may be employed for short term utilization. Such a policy prevents tourists and short term guests the hassle of obtaining a registration device. Issuance of guest cards is then controlled and tracked to ensure compliance and minimize abuse and fraud.

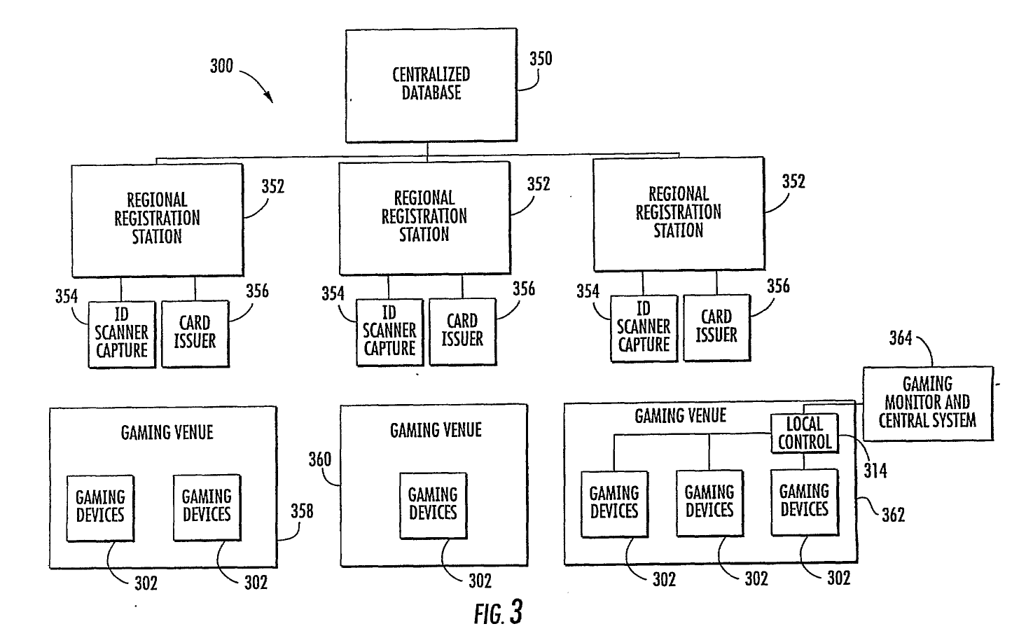

Turning now to FIG. 2, an embodiment of a personal device 200 is depicted. In one embodiment of the present invention, the personal device is a personal card device containing personal identifying and gaming information. A memory chip 230 is embedded in the personal card device 200 of the present embodiment. The memory in the device is non-volatile and will retain its data when it is removed from the machine for extended periods of time. The personal card device 200 may also contain a unique account number 231. The personal card device 200 will not identify the actual identity of the player to the VLT or anyone else other than a Gaming Authority. The device has no stored financial value. If it is lost, it cannot be used by any other individual. A player who loses their personal card device 200 will be required to return to the Gaming Authority and purchase another device. A personal card device 200 that has not been used for a very long period of time could be required to be re-registered by the authority in order to be re-activated.

The personal card device 200 itself may be manufactured in any number of formats. Examples may include, but are not limited to, a Smart Card, a radio frequency signal transmitting wand or fob, a card with a bar code, and Universal Serial Bus (“USB”) memory stick or peripheral devices. Existing technologies may be employed in order to keep costs low so that the cost of the device is not a hindrance in its installation.

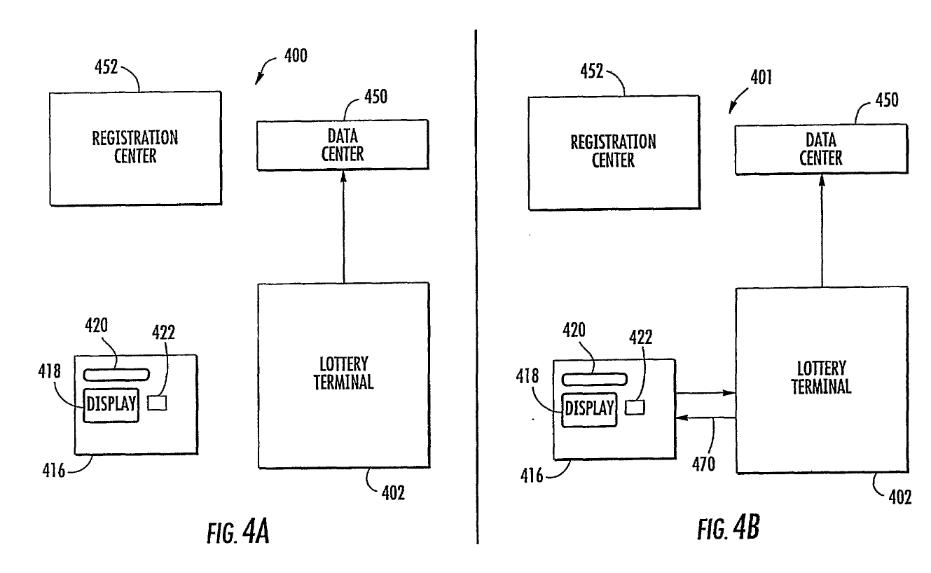

Turning now to FIG. 3 an organization chart 300 of a gaming registration structure is depicted in accordance with an embodiment of the present invention. As described above, a player wishing to take part in gaming through VLTs or other gaming machines may register with a gaming authority, or other regulatory body. The gaming authority organizes the registration data in a centralized database 350 that is in communication with several regional registration stations 352. At the regional registration station 352, a player presents valid photo identification, such as a driver's license or passport, and the player's name is run against the centralized database to ensure the player has not already been issued a personal device. The clerk at the regional registration station 352 uses an ID scanner-capture device 354 to read the information off of the valid photo identification. If all information is verified and the player has not already been issued a gaming device, the clerk may issue the player a personal device from the card issuer 356. The personal device from the card issuer contains identification information, including a biometric identifier in one embodiment, as well as the gaming loss limit information. The gaming authority has flexibility in establishing the loss limit on a case-by-case-basis depending on certain characteristics of the player. These characteristics may include, but are not limited to, annual income, credit ratings, debt defaults, registration with other regulatory bodies, criminal record, etc.

For instance, the loss limit parameters might be set so that any player may lose $50.00 net in any 24 hour period or $200 net in any weekly period. This limit is net of winnings such that if a player wins $500.00 they are permitted to then lose up to $550.00 in a single day resulting in a limit of $50.00 net loss to the player. Once a player reaches the loss limit set by the gaming authority, and stored on the personal device, the VLT or other gaming device is disabled, as described above.

An embodiment of the present invention allows the gaming venue 358 to be entirely independent of the registration network. A gaming venue 358-362 contains gaming devices 302 on its premises, but no communication with the centralized database 350 or the regional registration station 352 is permitted. In some gaming venues 362, the gaming devices are locally linked to a local controller 314 that drives the operation of the gaming devices 302. Certain gaming venues 362 may also be linked via a network to a gaming monitor and central system 364. In these circumstances, a player's use remains anonymous to the gaming authority and government. A player's playing habits, statistics, or other gaming information are not transmitted back to the registration network. This ensures a level of privacy among players who wish to keep their gaming activities anonymous. Additionally, anti-fraud procedures may be put into place, such as limitations on replacement devices, increasing replacement fees per loss, or a waiting period until a replacement device is provided.

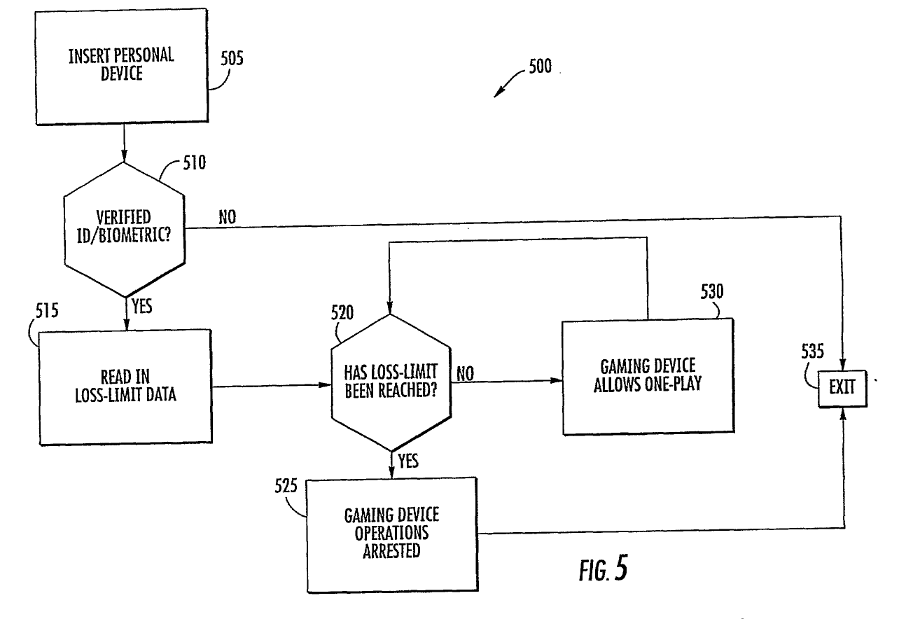

Turning now to FIG. 4A-4B, two implementations 400, 401 in accordance with the present invention are depicted in which a lottery terminal is utilized as a gaming terminal. FIG. 4A depicts a manual interface 400 in which a player must purchase a lottery ticket from a clerk or retailer. After a player has visited the registration center 452 and the gaming authority issues a personal device card to the player, he or she may participate in the lottery. A player hands the clerk the personal device card issued to him or her by the gaming authority. A fitment containing the verifying equipment is located behind or on a clerks counter. The clerk inserts the device card in to the card reader 420 and asks the player to input a biometric identifier, such as a fingerprint, to the biometric reader 422. Upon approval of the player's ability to participate in the lottery the clerk will issue a lottery ticket to the player. The ticket is printed from a standard lottery terminal 402 that is coupled to a data center 450 that tracks the purchase of tickets.

Alternatively, as depicted in FIG. 4B, an automated solution 401, without a clerk may be implemented. In this embodiment the fitment 416 communicates directly with the lottery terminal 402 via a network 470. The player inserts the personal device in to the card reader 420 and the display 418 asks the player to input a biometric identifier, such as a fingerprint, to the biometric reader 422. Upon approval of the player's ability to participate in the lottery the lottery terminal 402 will issue a lottery ticket to the player. The lottery terminal 402 is coupled to a data center 450 that tracks the purchase of tickets.

Although the embodiments depicted above detail the implementation of certain embodiments for a lottery, one skilled in the art should appreciate that any regulated gaming terminal may be implemented, e.g., Keno, pay-per-play games, video poker, slot machines, etc., without deviating from the scope of the present invention.

Turning now to FIG. 5, a method 500 of monitoring and controlling gaming is depicted. Once a player has obtained his or her personal device from the appropriate gaming authority, the player visits a location in which VLTs are available for play. The player inserts 505 his personal device in to the VLT. The players identity is verified 510 using the data stored on the personal device as well as a biometric identifier, in one embodiment. If the players identity is not verified the player may not continue and the VLT will not operate and the player must exit 535. If the player's identity is verified the VLT will read 515 in the loss-limit data stored on the personal device. The VLT will then determine whether the player's loss-limit has been reached 520. If the loss-limit has been reached, the VLT operations will be arrested 525 and the player will not be allowed to play (exit 535). If the limit has not yet been reached the VLT will allow a play 530. The VLT constantly monitors the players results and compares them against the loss-limit. Once the loss-limit is reached the VLT operations will cease 525 and the player will not be allowed any further play (exit 535).

While the present embodiments depict the implementation of monitoring and controlling gaming equipment, one skilled in the art should recognize that such an invention may be used in conjunction with the purchase of goods and services in which a government may have a substantial interest, e.g. tobacco, alcohol, etc. without deviating from the scope of the invention.

Additionally, although the embodiments described above depict gaming venues independent from the registration station and central database, one skilled in the art should recognize that a centralized system in which all VLTs or other gaming devices are networked to the central database may be implemented without deviating from the scope of the invention. Such an implementation implements a central decision making policy and requires less information to be stored in the personal device. Gaming information in such an implementation is stored centrally and not on a device card or local VLT controller.

Although the embodiments depicted above detail a loss limitation of $50 per day or $200 per week, one skilled in the art should recognize that any quantifiable amount of money or time may be implemented, in any combination, without deviating from the scope of the present invention.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A method for monitoring and controlling gaming equipment comprising:
providing a unique personal device;
verifying a player's identity using the unique personal device at a gaming terminal; and
operating the gaming terminal or not operating the gaming terminal in accordance with information received from the unique personal device.

2. The method of claim 1 further comprising setting a loss-limit for the player, the loss-limit allowing a maximum amount of money to be played in a given time period, the information received from the unique personal device comprising the loss-limit.

3. The method of claim 1, wherein the step of verifying the player's identity further comprises verifying a biometric datum from the player.

4. The method of claim 3, wherein the biometric datum is a fingerprint.

5. The method of claim 3 wherein the biometric datum is an ocular scan.

6. The method of claim 3 wherein the biometric datum is a facial recognition.

7. The method of claim 1, wherein the step of verifying the player's identity comprises verifying a personal identification number.

8. The method of claim 1 wherein the unique personal device is a SmartCard.

9. The method of claim 1 wherein said unique personal device is one of a card with a magnetic stripe, portable memory stick or radio-frequency device.

10. A gaming monitor and control device comprising:
a unique personal device comprising identifying data;
a device reader, the device reader configured to interface with a gaming terminal and the unique personal device;
a processor operatively connected to the device reader, the processor reading data from the device reader and stored on the unique personal device, the processor authorizing use of the gaming terminal in accordance with data received from the device reader and unique personal device.

11. The device of claim 10 wherein the data received from the unique personal device comprises a loss-limit, the loss-limit allowing a maximum amount of money to be played in a given time period.

12. The device of claim 10, further comprising a biometric reader, the biometric reader verifying a biometric datum from the player.

13. The device of claim 12, wherein the biometric datum is one of a fingerprint, an ocular scan, or a facial recognition.

14. The method of claim 10, wherein the step identifying data comprises a personal identification number.

15. The device of claim 10 wherein the gaming terminal is one of a video gaming terminal, slot machine, video poker, lottery terminal, Keno terminal, or a pay-per-play game.

16. The method of claim 10 wherein said unique personal device is one of a card with a magnetic stripe, SmartCard, portable memory stick or radio-frequency device.

17. A method for monitoring and controlling the use of regulated goods and services comprising:
providing a unique personal device;
verifying a purchasers identity using the unique personal device at a goods and services terminal; and
operating the goods and services terminal or not operating the goods and services terminal in accordance with information received from the unique personal device.

18. The method of claim 17 further comprising setting a limit for the purchaser, the limit allowing a maximum amount of money to be spent on the goods and services in a given time period, the information received from the unique personal device comprising the limit.

19. The method of claim 18 wherein the goods and services terminal comprises one of a gaming terminal, video poker terminal, lottery terminal, Keno terminal, pay-per-play terminal, tobacco vendor, alcohol vender.

20. The method of claim 17, wherein the step of verifying the purchaser's identity includes of one of personal identification number, fingerprint scan, ocular scan, facial recognition scan.
